(19) United States
(12) Patent Application Publication
(10) Pub. No.: US 2025/0138258 A1
(43) Pub. Date: May 1, 2025

(54) CHIP PACKAGE STRUCTURE WITH PHOTONIC INTEGRATED CIRCUIT CHIP AND METHOD FOR FORMING THE SAME

(71) Applicant: Taiwan Semiconductor Manufacturing Company, Ltd., Hsinchu (TW)

(72) Inventors: Shih-Wei LIANG, Taichung City (TW); Jiun-Yi WU, Taoyuan City (TW)

(73) Assignee: Taiwan Semiconductor Manufacturing Company, Ltd., Hsinchu (TW)

(21) Appl. No.: 18/499,785

(22) Filed: Nov. 1, 2023

(51) Int. Cl. G02B 6/42

(52) U.S. Cl. CPC G02B 6/4214; G02B 6/4206; G02B 6/4257; G02B 6/4274

(57) ABSTRACT

A chip package structure is provided. The chip package structure includes a photonic integrated circuit chip including a dielectric structure, a photodetector, an optical modulator, and a first waveguide structure in the dielectric structure. The photodetector and the optical modulator are connected to the first waveguide structure. The chip package structure includes an electronic integrated circuit chip over the photonic integrated circuit chip. The chip package structure includes an optical transmission chip over the photonic integrated circuit chip. The optical transmission chip includes a substrate, a second waveguide structure, and a first reflective structure.

### BACKGROUND

Semiconductor devices are used in a variety of electronic applications, such as personal computers, cell phones, digital cameras, and other electronic equipment. Semiconductor devices are typically fabricated by sequentially depositing insulating layers or dielectric layers, conductive layers, and semiconductor layers over a semiconductor substrate, and patterning the various material layers using photolithography processes and etching processes to form circuit components and elements thereon.

Many integrated circuits (IC) are typically manufactured on a semiconductor wafer. Technological advances in IC materials and design have produced generations of ICs. Each generation has smaller and more complex circuits than the previous generation. The dies of the wafer may be processed and packaged at the wafer level, and various technologies have been developed for wafer level packaging. Since the chip package structure may need to include multiple chips with multiple functions, it is a challenge to form a reliable chip package structure with multiple chips.

### BRIEF DESCRIPTION OF THE DRAWINGS

Aspects of the present disclosure are best understood from the following detailed description when read with the accompanying figures. It should be noted that, in accordance with standard practice in the industry, various features are not drawn to scale. In fact, the dimensions of the various features may be arbitrarily increased or reduced for clarity of discussion.

FIG. 1A is a cross-sectional view of a chip package structure, in accordance with some embodiments.

FIG. 1B is a flow chart illustrating a method for performing a chip package structure, in accordance with some embodiments.

FIG. 1C is a top view of the end portions of the lowermost two of the waveguide layers of the chip package structure of FIG. 1A, in accordance with some embodiments.

FIG. 2 is a cross-sectional view of a chip package structure, in accordance with some embodiments.

FIG. 3 is a cross-sectional view of a chip package structure, in accordance with some embodiments.

FIG. 4 is a cross-sectional view of a chip package structure, in accordance with some embodiments.

FIG. 5 is a cross-sectional view of a chip package structure, in accordance with some embodiments.

### DETAILED DESCRIPTION

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Some embodiments of the disclosure are described. Additional operations can be provided before, during, and/or after the stages described in these embodiments. Some of the stages that are described can be replaced or eliminated for different embodiments. Additional features can be added to the semiconductor device structure. Some of the features described below can be replaced or eliminated for different embodiments. Although some embodiments are discussed with operations performed in a particular order, these operations may be performed in another logical order.

The methods (for forming the chip package structure) form an additional optical transmission chip in an optical engine package structure to change the light path so as to reduce the light path length. Therefore, the path loss of the optical signal is reduced. The methods (for forming the chip package structure) form a convex lens in an optical engine package structure to concentrate the optical signal, which reduces the path loss of the optical signal.

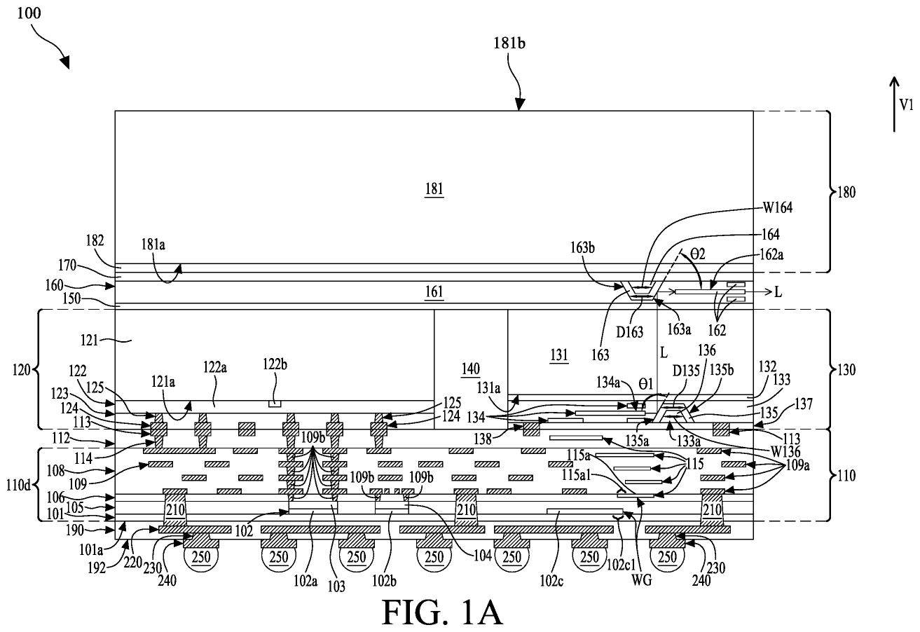

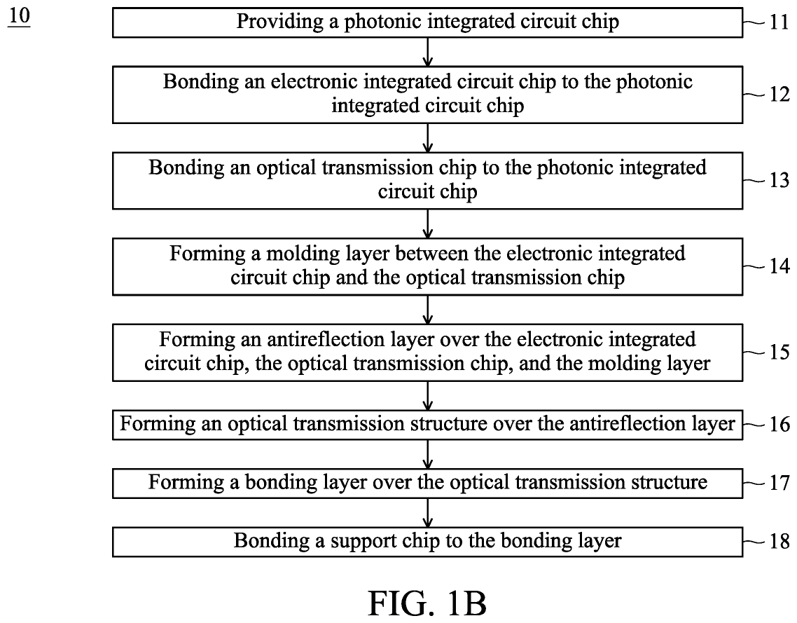

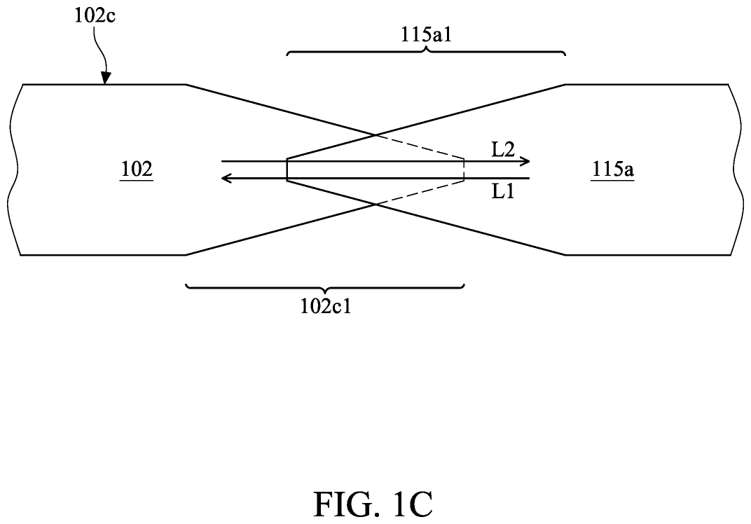

FIG. 1A is a cross-sectional view of a chip package structure, in accordance with some embodiments. FIG. 1B is a flow chart illustrating a method for performing a chip package structure, in accordance with some embodiments.

As shown in FIGS. 1A and 1B, the method 10 begins with an operation 11 in which a photonic integrated circuit chip 110 is provided, in accordance with some embodiments. The photonic integrated circuit chip 110 may include a dielectric structure 110d, one or more photodetectors (PD) 103, one or more optical modulators 104, an interconnect structure 109, bonding pads 113, conductive vias 114, and a waveguide structure WG, in accordance with some embodiments. It should be noted that, for the sake of simplicity, FIG. 1A shows one of the optical modulators 104 and one of the photodetectors 103 for illustration, but does not limit the invention thereto.

The photodetectors 103, the optical modulators 104, the interconnect structure 109, the bonding pads 113, the conductive vias 114, and the waveguide structure WG are in the dielectric structure 110d, in accordance with some embodiments. Specifically, the dielectric structure 110d includes dielectric layers 101, 105, 106, 108, and 112, in accordance with some embodiments. The dielectric layers 105, 106, 108, and 112 are sequentially stacked over the dielectric layer 101, in accordance with some embodiments.

The waveguide structure WG has waveguide layers 102 and 115, in accordance with some embodiments. The waveguide layer 102 is formed over the dielectric layer 101, in accordance with some embodiments. The waveguide layer 102 has portions 102a, 102b, and 102c, in accordance with some embodiments. The photodetectors 103 and the optical modulators 104 are formed over the portions 102a and 102b respectively, in accordance with some embodiments. The photodetectors 103 and the optical modulators 104 are coupled to (or connected to) the waveguide structure WG, in accordance with some embodiments.

Each photodetector 103 is used to receive an optical signal transmitted through the waveguide structure WG and convert the optical signal into an electrical signal, in accordance with some embodiments. Each optical modulator 104 is used to receive an electrical signal and convert the electrical signal into an optical signal, in accordance with some embodiments.

In the photonic integrated circuit chip 110, the optical signal is transmitted through the waveguide structure WG, and the electrical signal is transmitted through the interconnect structure 109, the bonding pads 113, the conductive vias 114, in accordance with some embodiments. The waveguide layer 102 is made of a semiconductor material such as silicon, in accordance with some embodiments.

Each photodetector 103 has a left portion, a middle portion, and a right portion, in accordance with some embodiments. The left portion is made of a semiconductor material (e.g., silicon) with P-type dopants, in accordance with some embodiments. The P-type dopants include the Group IIIA element, in accordance with some embodiments. The Group IIIA element includes boron or another suitable material.

The middle portion is made of an alloy semiconductor material (e.g., silicon germanium), in accordance with some embodiments. The right portion is made of a semiconductor material (e.g., silicon) with N-type dopants, in accordance with some embodiments. The N-type dopants include the Group VA element, in accordance with some embodiments. The Group VA element includes phosphor (P), antimony (Sb), or another suitable Group VA material.

Each optical modulator 104 has a left portion and a right portion, in accordance with some embodiments. The left portion is made of a semiconductor material (e.g., silicon) with P-type dopants, in accordance with some embodiments. The P-type dopants include the Group IIIA element, in accordance with some embodiments. The Group IIIA element includes boron or another suitable material.

The right portion is made of a semiconductor material (e.g., silicon) with N-type dopants, in accordance with some embodiments. The N-type dopants include the Group VA element, in accordance with some embodiments. The Group VA element includes phosphor (P), antimony (Sb), or another suitable Group VA material.

The dielectric layer 105 is formed over the dielectric layer 101, in accordance with some embodiments. The waveguide layer 102, the photodetectors 103, and the optical modulators 104 are in the dielectric layer 105, in accordance with some embodiments. The dielectric layer 106 is formed over the dielectric layer 105, the photodetectors 103, and the optical modulators 104, in accordance with some embodiments.

The interconnect structure 109 includes wiring layers 109a and conductive vias 109b, in accordance with some embodiments. The conductive vias 109b are connected between the wiring layers 109a, between the lowermost wiring layer 109a and the photodetectors 103, and between the lowermost wiring layer 109a and the optical modulators 104, in accordance with some embodiments.

Some of the lowermost conductive vias 109b pass through the dielectric layer 106 to electrically connect the lowermost wiring layer 109a with the photodetectors 103, and the other some of the lowermost conductive vias 109b pass through the dielectric layer 106 to electrically connect the lowermost wiring layer 109a with the optical modulators 104, in accordance with some embodiments.

The dielectric layer 108 is formed over the dielectric layer 106, in accordance with some embodiments. The interconnect structure 109 is in the dielectric layer 108, in accordance with some embodiments. The dielectric layer 112 is formed over the dielectric layer 108 and the interconnect structure 109, in accordance with some embodiments.

The dielectric layers 101, 105, 106, 108, and 112 are made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments. Alternatively, the dielectric layers 101, 105, 106, 108, and 112 include a low-k material or a porous dielectric material having a k-value which is lower than that of silicon oxide, or lower than about 3.0 or about 2.5, in accordance with some embodiments.

The dielectric layers 101, 105, 106, 108, and 112 are formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The interconnect structure 109 is made of a conductive material, such as metal (e.g., copper, aluminum, gold, silver, or tungsten) or alloys thereof, in accordance with some embodiments.

The bonding pads 113 and the conductive vias 114 are formed in the dielectric layer 112, in accordance with some embodiments. The conductive vias 114 are connected between the bonding pads 113 and the interconnect structure 109, in accordance with some embodiments. The bonding pads 113 and the conductive vias 114 are made of a conductive material, such as metal (e.g., copper, aluminum, gold, silver, or tungsten) or alloys thereof, in accordance with some embodiments.

The waveguide layers 115 are formed in the dielectric layers 106, 108, and 112, in accordance with some embodiments. FIG. 1C is a top view of the end portions of the lowermost two of the waveguide layers of the chip package structure of FIG. 1A, in accordance with some embodiments. As shown in FIGS. 1A and 1C, the portion 102c of the waveguide layer 102 has a tapered end portion 102c1, and the lowermost waveguide layer 115a of the waveguide layers 115 has a tapered end portion 115al, in accordance with some embodiments. The tapered end portion 115al overlaps the tapered end portion 102c1, in accordance with some embodiments.

In some embodiments, the tapered end portion 102cl is used as an input port for receiving a light signal L1. In some other embodiments, the tapered end portion 102cl is used as an output port for output of a light signal L2.

In some embodiments, the tapered end portion 115al is used as an input port for receiving the light signal L2. In some embodiments, the tapered end portion 115a1 is used as an output port for output of the light signal L1.

In some embodiments, the light signal L1 is transmitted from the waveguide layer 115a to the waveguide layer 102 through the tapered end portions 115al and 102c1, in accordance with some embodiments. In some other embodiments, the light signal L2 is transmitted from the waveguide layer 102 to the waveguide layer 115a through the tapered end portions 102c1 and 115al, in accordance with some embodiments.

The waveguide layers 115 are made of a nitride-containing material (e.g., silicon nitride) or a lithium-containing material (e.g., LiNiO₂), in accordance with some embodiments. In some embodiments, the waveguide layers 102 and 115 are made of different materials.

As shown in FIGS. 1A and 1B, the method 10 continues with an operation 12 in which an electronic integrated circuit chip 120 is bonded to the photonic integrated circuit chip 110, in accordance with some embodiments. The electronic integrated circuit chip 120 includes a substrate 121, a device layer 122, a dielectric layer 123, bonding pads 124, and conductive vias 125, in accordance with some embodiments.

The substrate 121 has a front surface 121a, in accordance with some embodiments. The substrate 121 includes, for example, a semiconductor substrate. In some embodiments, the substrate 121 is made of an elementary semiconductor material including silicon or germanium in a single crystal structure, a polycrystal structure, or an amorphous structure. In some other embodiments, the substrate 121 is made of a compound semiconductor, such as silicon carbide, gallium arsenide, gallium phosphide, indium phosphide, indium arsenide, an alloy semiconductor, such as SiGe or GaAsP, or a combination thereof. The substrate 121 may also include multi-layer semiconductors, semiconductor on insulator (SOI) (such as silicon on insulator or germanium on insulator), or a combination thereof.

In some embodiments, active regions and isolation features (not shown) are formed in the substrate 121. The isolation features are used to surround active regions and electrically isolate various device elements formed in and/or over the substrate 121 in the active regions. In some embodiments, the isolation features include shallow trench isolation (STI) features, local oxidation of silicon (LOCOS) features, other suitable isolation features, or a combination thereof.

The device layer 122 is formed over the front surface 121a, in accordance with some embodiments. The device layer 122 includes a dielectric layer 122a, various device elements, and an interconnect structure (not shown) in the dielectric layer 122a, in accordance with some embodiments.

The dielectric layer 122a is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments. Alternatively, the dielectric layer 122a includes a low-k material or a porous dielectric material having a k-value which is lower than that of silicon oxide, or lower than about 3.0 or about 2.5, in accordance with some embodiments.

The dielectric layer 122a is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The device elements are formed in and/or over the substrate 121, in accordance with some embodiments. Examples of the various device elements include active devices, passive devices, other suitable elements, or a combination thereof. The active devices may include transistors 122b or diodes (not shown) formed at the front surface 121a of the substrate 121. The passive devices include resistors, capacitors, or other suitable passive devices.

For example, the transistors 122b may be metal oxide semiconductor field effect transistors (MOSFET), complementary metal oxide semiconductor (CMOS) transistors, bipolar junction transistors (BJT), high-voltage transistors, high-frequency transistors, p-channel and/or n-channel field effect transistors (PFETs/NFETs), etc.

Various processes, such as front-end-of-line (FEOL) semiconductor fabrication processes, are performed to form the various device elements. The FEOL semiconductor fabrication processes may include deposition, etching, implantation, photolithography, annealing, planarization, one or more other applicable processes, or a combination thereof.

The interconnect structure are electrically connected between the various device elements, the bonding pads 124, and the conductive vias 125, in accordance with some embodiments. The interconnect structure includes wiring layers and conductive vias, in accordance with some embodiments.

The conductive vias are connected between the wiring layers and between the device elements and the wiring layer, in accordance with some embodiments. The interconnect structure is made of a conductive material, such as metal (e.g., copper, aluminum, gold, silver, or tungsten) or alloys thereof, in accordance with some embodiments.

The dielectric layer 123 is formed over the device layer 122, in accordance with some embodiments. The dielectric layer 123 is directly bonded with the dielectric layer 112 of the photonic integrated circuit chip 110, in accordance with some embodiments.

The dielectric layer 123 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 123 includes a low-k material or a porous dielectric material having a k-value which is lower than that of silicon oxide, or lower than about 3.0 or about 2.5, in accordance with some embodiments.

The dielectric layer 123 is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The bonding pads 124 and the conductive vias 125 are formed in the dielectric layer 123, in accordance with some embodiments. The conductive vias 125 are connected between the bonding pads 124 and the interconnect structure of the device layer 122, in accordance with some embodiments. The bonding pads 124 are directly bonded with the bonding pads 113 of the photonic integrated circuit chip 110, in accordance with some embodiments.

The bonding pads 124 and the conductive vias 125 are made of a conductive material, such as metal (e.g., copper, aluminum, gold, silver, or tungsten) or alloys thereof, in accordance with some embodiments.

As shown in FIGS. 1A and 1B, the method 10 continues with an operation 13 in which an optical transmission chip 130 is bonded to the photonic integrated circuit chip 110, in accordance with some embodiments. The optical transmission chip 130 includes a substrate 131, an antireflection layer 132, a dielectric layer 133, a waveguide structure 134, a reflective structure 135, a dielectric layer 136, a dielectric layer 137, and bonding pads 138, in accordance with some embodiments. The optical transmission chip 130 does not include active devices (e.g., transistors or diodes) and/or passive devices (e.g., resistors or capacitors), in accordance with some embodiments.

The substrate 131 has a lower surface 131a facing the photonic integrated circuit chip 110, in accordance with some embodiments. The substrate 131 includes, for example, a semiconductor substrate. In some embodiments, the substrate 131 is made of an elementary semiconductor material including silicon or germanium in a single crystal structure, a polycrystal structure, or an amorphous structure.

In some other embodiments, the substrate 131 is made of a compound semiconductor, such as silicon carbide, gallium arsenide, gallium phosphide, indium phosphide, indium arsenide, an alloy semiconductor, such as SiGe or GaAsP, or a combination thereof. The substrate 131 may also include multi-layer semiconductors, semiconductor on insulator (SOI) (such as silicon on insulator or germanium on insulator), or a combination thereof.

The antireflection layer 132 is formed over the lower surface 131a, in accordance with some embodiments. The antireflection layer 132 is made of a nitride-containing material (e.g., silicon nitride), an oxide-containing material (e.g., SiO₂ or Ta₂O₅), or another suitable material with a high light transmittance, which is higher than 99%, in accordance with some embodiments.

The dielectric layer 133 is formed over the antireflection layer 132, in accordance with some embodiments. The dielectric layer 133 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments. Alternatively, the dielectric layer 133 includes a low-k material or a porous dielectric material having a k-value which is lower than that of silicon oxide, or lower than about 3.0 or about 2.5, in accordance with some embodiments.

The dielectric layer 133 is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The waveguide structure 134 is formed in the dielectric layer 133, in accordance with some embodiments. The waveguide structure 134 includes waveguide layers, in accordance with some embodiments. The waveguide structure WG overlaps the waveguide structure 134 in a direction V1 perpendicular to the lower surface 131a of the substrate 131, in accordance with some embodiments. The waveguide structure 134 is made of a nitride-containing material (e.g., silicon nitride) or a lithium-containing material (e.g., LiNiO₂), in accordance with some embodiments.

The reflective structure 135 is formed in the dielectric layer 133, in accordance with some embodiments. The reflective structure 135 has a trapezoidal shape, in accordance with some embodiments. The reflective structure 135 has opposite sidewalls 135a and 135b, in accordance with some embodiments.

The sidewalls 135a and 135b are sloped sidewalls, in accordance with some embodiments. In some embodiments, a distance D135 between the sidewalls 135a and 135b decreases toward the substrate 131. The antireflection layer 132 is between the reflective structure 135 and the substrate 131, in accordance with some embodiments.

The waveguide structure 134 and the reflective structure 135 are between the substrate 131 and the photonic integrated circuit chip 110, in accordance with some embodiments. In some embodiments, an angle θ1 between an upper surface 134a of the waveguide structure 134 and the sidewall 135a of the reflective structure 135 is greater than 90 degrees and less than 180 degrees, in accordance with some embodiments. The angle θ1 ranges from about 130 degrees to about 140 degrees, in accordance with some embodiments. The sidewall 135a is adjacent to the waveguide structure 134, in accordance with some embodiments.

The reflective structure 135 is made of metal (e.g., copper, aluminum, gold, silver, or tungsten), alloys thereof, a semiconductor material (e.g., amorphous silicon), an oxide-containing material, a dielectric material, or another suitable material with a high light reflectivity, which is higher than 99%, in accordance with some embodiments.

The dielectric layer 136 is formed in the reflective structure 135, in accordance with some embodiments. The dielectric layer 136 has a trapezoidal shape, in accordance with some embodiments. The width W136 of the dielectric layer 136 decreases toward the substrate 131, in accordance with some embodiments.

The dielectric layer 136 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 136 includes a low-k material or a porous dielectric material having a k-value which is lower than that of silicon oxide, or lower than about 3.0 or about 2.5, in accordance with some embodiments. In some embodiments, the dielectric layers 133 and 136 are made of the same material.

The method for forming the reflective structure 135 and the dielectric layer 136 includes: partially removing the dielectric layer 133 to form a recess 133a in the dielectric layer 133; conformally depositing a reflective material layer (not shown) over the dielectric layer 133 and in the recess 133a; depositing a dielectric material layer (not shown) over the reflective material layer and in the recess 133a; and removing the reflective material layer and the dielectric material layer outside the recess 133a, in accordance with some embodiments.

The reflective material layer remaining in the recess 133a forms the reflective structure 135, in accordance with some embodiments. The dielectric material layer remaining in the recess 133a forms the dielectric layer 136, in accordance with some embodiments.

The deposition process includes a chemical vapor deposition (CVD) process, such as a low-pressure CVD process, a plasma-enhanced CVD process, or a high-density plasma CVD process, an atomic layer deposition process, a physical vapor deposition process, or another suitable process. The removal process of the reflective material layer and the dielectric material layer outside the recess 133a includes a planarization process such as a chemical mechanical polishing process, in accordance with some embodiments.

The dielectric layer 137 is formed over the dielectric layers 133 and 136 and the reflective structure 135, in accordance with some embodiments. The dielectric layer 137 is directly bonded with the dielectric layer 112 of the photonic integrated circuit chip 110, in accordance with some embodiments.

The dielectric layer 137 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 137 includes a low-k material or a porous dielectric material having a k-value which is lower than that of silicon oxide, or lower than about 3.0 or about 2.5, in accordance with some embodiments.

The dielectric layer 137 is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The bonding pads 138 are formed in the dielectric layer 137, in accordance with some embodiments. The bonding pads 138 are directly bonded with the bonding pads 113 of the photonic integrated circuit chip 110, in accordance with some embodiments. The bonding pads 138 are made of a conductive material, such as metal (e.g., copper, aluminum, gold, silver, or tungsten) or alloys thereof, in accordance with some embodiments.

As shown in FIGS. 1A and 1B, the method 10 continues with an operation 14 in which a molding layer 140 is formed between the electronic integrated circuit chip 120 and the optical transmission chip 130, in accordance with some embodiments. The molding layer 140 is made of a polymer material or another suitable insulating material.

The polymer material includes thermosetting polymers, thermoplastic polymers, or mixtures thereof. The polymer material includes, for example, plastic materials, epoxy resin, polyimide, polyethylene terephthalate (PET), polyvinyl chloride (PVC), polymethylmethacrylate (PMMA), polymer components doped with fillers including fiber, clay, silica, glass, ceramic, inorganic particles, or combinations thereof.

As shown in FIGS. 1A and 1B, the method 10 continues with an operation 15 in which an antireflection layer 150 is formed over the electronic integrated circuit chip 120, the optical transmission chip 130, and the molding layer 140, in accordance with some embodiments.

The antireflection layer 150 is made of a nitride-containing material (e.g., silicon nitride), an oxide-containing material (e.g., SiO₂ or Ta₂O₅), or another suitable material with a high light transmittance, which is higher than 99%, in accordance with some embodiments.

As shown in FIGS. 1A and 1B, the method 10 continues with an operation 16 in which an optical transmission structure 160 is formed over the antireflection layer 150, in accordance with some embodiments. The optical transmission structure 160 includes a dielectric layer 161, a waveguide structure 162, a reflective structure 163, and a dielectric layer 164, in accordance with some embodiments.

The dielectric layer 161 is formed over the antireflection layer 150, in accordance with some embodiments. The dielectric layer 161 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments. Alternatively, the dielectric layer 161 includes a low-k material or a porous dielectric material having a k-value which is lower than that of silicon oxide, or lower than about 3.0 or about 2.5, in accordance with some embodiments.

The dielectric layer 161 is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The waveguide structure 162 is formed in the dielectric layer 161, in accordance with some embodiments. The waveguide structure 162 includes waveguide layers, in accordance with some embodiments. The waveguide structure 162 is made of a nitride-containing material (e.g., silicon nitride) or a lithium-containing material (e.g., LiNiO₂), in accordance with some embodiments.

The reflective structure 163 is formed in the dielectric layer 161, in accordance with some embodiments. The reflective structure 163 has a trapezoidal shape, in accordance with some embodiments. The reflective structure 163 has opposite sidewalls 163a and 163b, in accordance with some embodiments. The distance D163 between the sidewalls 163a and 163b decreases toward the substrate 131, in accordance with some embodiments.

In some embodiments, an angle θ2 between an upper surface 162a of the waveguide structure 162 and the sidewall 163a of the reflective structure 163 is greater than 0 degree and less than 90 degrees. The angle θ2 ranges from about 40 degrees to about 50 degrees, in accordance with some embodiments. The sidewall 163a is adjacent to the waveguide structure 162, in accordance with some embodiments.

The sidewall 135a of the reflective structure 135 overlaps the sidewall 163a of the reflective structure 163 in the direction V1 perpendicular to the lower surface 131a of the substrate 131, in accordance with some embodiments. The antireflection layer 150 is between the reflective structure 163 and the substrate 131, in accordance with some embodiments.

The reflective structure 163 is made of metal (e.g., copper, aluminum, gold, silver, or tungsten), alloys thereof, a semiconductor material (e.g., amorphous silicon), an oxide-containing material, a dielectric material, or another suitable material with a high light reflectivity, which is higher than 99%, in accordance with some embodiments.

The dielectric layer 164 is formed in the reflective structure 163, in accordance with some embodiments. The dielectric layer 164 has a trapezoidal shape, in accordance with some embodiments. The width W164 of the dielectric layer 164 decreases toward the substrate 131 of the optical transmission chip 130, in accordance with some embodiments.

The dielectric layer 164 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 164 includes a low-k material or a porous dielectric material having a k-value which is lower than that of silicon oxide, or lower than about 3.0 or about 2.5, in accordance with some embodiments. In some embodiments, the dielectric layers 133 and 164 are made of the same material.

As shown in FIGS. 1A and 1B, the method 10 continues with an operation 17 in which a bonding layer 170 is formed over the optical transmission structure 160, in accordance with some embodiments. The bonding layer 170 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the bonding layer 170 includes a low-k material or a porous dielectric material having a k-value which is lower than that of silicon oxide, or lower than about 3.0 or about 2.5, in accordance with some embodiments.

The bonding layer 170 is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

As shown in FIGS. 1A and 1B, the method 10 continues with an operation 18 in which a support chip 180 is bonded to the bonding layer 170, in accordance with some embodiments. The support chip 180 includes a substrate 181 and a bonding layer 182, in accordance with some embodiments. The substrate 181 has a surface 181a, in accordance with some embodiments. The bonding layer 182 is formed over the surface 181a, in accordance with some embodiments. The bonding layer 182 is directly bonded with the bonding layer 170, in accordance with some embodiments.

The substrate 181 includes, for example, a semiconductor substrate. In some embodiments, the substrate 181 is made of an elementary semiconductor material including silicon or germanium in a single crystal structure, a polycrystal structure, or an amorphous structure.

In some other embodiments, the substrate 181 is made of a compound semiconductor, such as silicon carbide, gallium arsenide, gallium phosphide, indium phosphide, indium arsenide, an alloy semiconductor, such as SiGe or GaAsP, or a combination thereof. The substrate 181 may also include multi-layer semiconductors, semiconductor on insulator (SOI) (such as silicon on insulator or germanium on insulator), or a combination thereof.

The bonding layer 182 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the bonding layer 182 includes a low-k material or a porous dielectric material having a k-value which is lower than that of silicon oxide, or lower than about 3.0 or about 2.5, in accordance with some embodiments.

The bonding layer 182 is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

As shown in FIG. 1A, a dielectric layer 190 is formed over a surface 101a of the dielectric layer 101, in accordance with some embodiments. The dielectric layer 190 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 190 includes a low-k material or a porous dielectric material having a k-value which is lower than that of silicon oxide, or lower than about 3.0 or about 2.5, in accordance with some embodiments.

The dielectric layer 190 is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

As shown in FIG. 1A, conductive plugs 210 are formed in the dielectric layers 101, 105, 106, and 190, in accordance with some embodiments. The conductive plugs 210 are made of a conductive material, such as metal (e.g., copper, aluminum, gold, silver, or tungsten) or alloys thereof, in accordance with some embodiments.

As shown in FIG. 1A, a wiring layer 220 is formed in the dielectric layer 190, in accordance with some embodiments. The wiring layer 220 is made of a conductive material, such as metal (e.g., copper, aluminum, gold, silver, or tungsten) or alloys thereof, in accordance with some embodiments.

As shown in FIG. 1A, conductive vias 230 are formed in the dielectric layer 190, and conductive pads 240 are formed over a surface 192 of the dielectric layer 190, in accordance with some embodiments. The conductive vias 230 are connected between the wiring layer 220 and the conductive pads 240, in accordance with some embodiments.

The conductive vias 230 and the conductive pads 240 are made of a conductive material, such as metal (e.g., copper, aluminum, gold, silver, or tungsten) or alloys thereof, in accordance with some embodiments.

As shown in FIG. 1A, conductive bumps 250 are formed over the conductive pads 240 respectively, in accordance with some embodiments. The conductive bumps 250 are made of a conductive material, such as a tin-based alloy, in accordance with some embodiments. In this step, a chip package structure 100 is substantially formed, in accordance with some embodiments. The chip package structure 100 is also referred to as an optical engine package structure, in accordance with some embodiments.

As shown in FIG. 1A, the optical signal L passes through the waveguide structure 134, is reflected by the sidewall 135a of the reflective structure 135, passes through the substrate 131, is reflected by the sidewall 163a of the reflective structure 163, and passes through the waveguide structure 162, in accordance with some embodiments.

In some ordinary embodiments, the optical signal (not shown) from the photonic integrated circuit chip 110 passes through the molding layer 140 and the support chip 180. The light path length of the optical signal L of the application is less than the ordinary light path length, which reduces the path loss of the optical signal L, in accordance with some embodiments.

Since the optical transmission chip 130 and the optical transmission structure 160 reduce the light path length of the optical signal L, the performance of the chip package structure 100 is improved, in accordance with some embodiments.

Since the coefficients of thermal expansion (CTE) of the optical transmission chip 130 and the optical transmission structure 160 are similar to that of the photonic integrated circuit chip 110, the electronic integrated circuit chip 120, and the support chip 180, there is no additional CTE matching issue, in accordance with some embodiments.

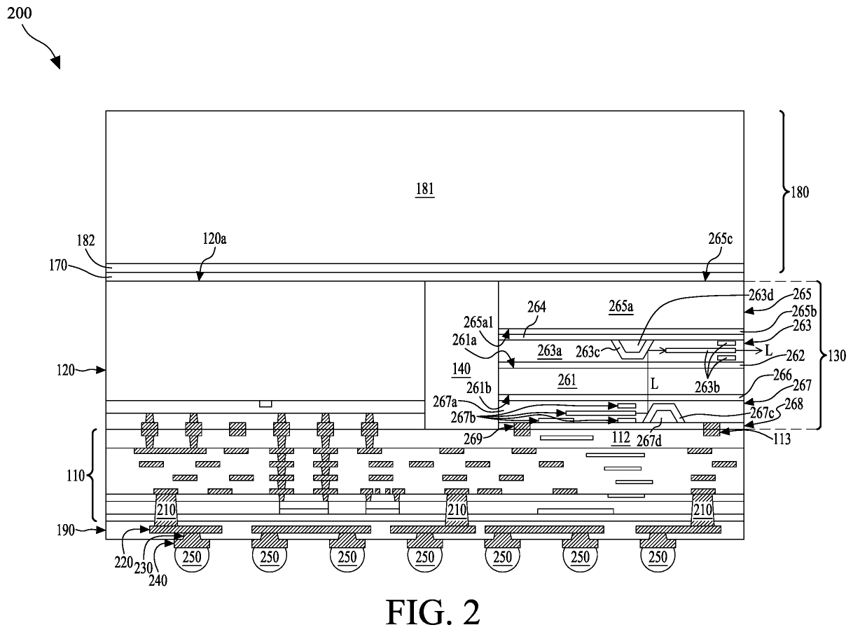

FIG. 2 is a cross-sectional view of a chip package structure 200, in accordance with some embodiments. As shown in FIG. 2, the chip package structure 200 is similar to the chip package structure 100 of FIG. 1A, except that the chip package structure 200 has an optical transmission structure 260 to replace the optical transmission chip 130 of the chip package structure 100 of FIG. 1A, in accordance with some embodiments. Furthermore, the chip package structure 200 does not include the antireflection layer 150 and the optical transmission structure 160 of the chip package structure 100 of FIG. 1A, in accordance with some embodiments.

The optical transmission structure 260 includes a substrate 261, an antireflection layer 262, an optical transmission structure 263, a bonding layer 264, a dummy chip 265, an antireflection layer 266, an optical transmission structure 267, a dielectric layer 268, and bonding pads 269, in accordance with some embodiments.

The substrate 261 includes, for example, a semiconductor substrate. In some embodiments, the substrate 261 is made of an elementary semiconductor material including silicon or germanium in a single crystal structure, a polycrystal structure, or an amorphous structure.

In some other embodiments, the substrate 261 is made of a compound semiconductor, such as silicon carbide, gallium arsenide, gallium phosphide, indium phosphide, indium arsenide, an alloy semiconductor, such as SiGe or GaAsP, or a combination thereof. The substrate 261 may also include multi-layer semiconductors, semiconductor on insulator (SOI) (such as silicon on insulator or germanium on insulator), or a combination thereof.

The antireflection layer 262 is formed over a surface 261a of the substrate 261, in accordance with some embodiments. The antireflection layer 262 is made of a nitride-containing material (e.g., silicon nitride), an oxide-containing material (e.g., SiO₂ or Ta₂O₅), or another suitable material with a high light transmittance, which is higher than 99%, in accordance with some embodiments.

The optical transmission structure 263 is formed over the antireflection layer 262, in accordance with some embodiments. The optical transmission structure 263 includes a dielectric layer 263a, a waveguide structure 263b, a reflective structure 263c, and a dielectric layer 263d, in accordance with some embodiments.

The dielectric layer 263a is formed over the antireflection layer 262, in accordance with some embodiments. The dielectric layer 263a is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments. Alternatively, the dielectric layer 263a includes a low-k material or a porous dielectric material having a k-value which is lower than that of silicon oxide, or lower than about 3.0 or about 2.5, in accordance with some embodiments.

The dielectric layer 263a is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The waveguide structure 263b is formed in the dielectric layer 263a, in accordance with some embodiments. The waveguide structure 263b includes waveguide layers, in accordance with some embodiments. The waveguide structure 263b is made of a nitride-containing material (e.g., silicon nitride) or a lithium-containing material (e.g., LiNiO₂), in accordance with some embodiments.

The reflective structure 263c is formed in the dielectric layer 263a, in accordance with some embodiments. The reflective structure 263c has a trapezoidal shape, in accordance with some embodiments. The reflective structure 263c is made of metal (e.g., copper, aluminum, gold, silver, or tungsten), alloys thereof, a semiconductor material (e.g., amorphous silicon), an oxide-containing material, a dielectric material, or another suitable material with a high light reflectivity, which is higher than 99%, in accordance with some embodiments.

The dielectric layer 263d is formed in the reflective structure 263c, in accordance with some embodiments. The dielectric layer 263d has a trapezoidal shape, in accordance with some embodiments. The dielectric layer 263d is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 263d includes a low-k material or a porous dielectric material having a k-value which is lower than that of silicon oxide, or lower than about 3.0 or about 2.5, in accordance with some embodiments. In some embodiments, the dielectric layers 263a and 263d are made of the same material.

The bonding layer 264 is formed over the optical transmission structure 263, in accordance with some embodiments. The bonding layer 264 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the bonding layer 264 includes a low-k material or a porous dielectric material having a k-value which is lower than that of silicon oxide, or lower than about 3.0 or about 2.5, in accordance with some embodiments.

The bonding layer 264 is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The dummy chip 265 is bonded to the bonding layer 264, in accordance with some embodiments. In some embodiments, a top surface 265c of the dummy chip 265 is substantially level with a top surface 120a of the electronic integrated circuit chip 120. The dummy chip 265 includes a substrate 265a and a bonding layer 265b, in accordance with some embodiments. The substrate 265a has a surface 265al, in accordance with some embodiments. The bonding layer 265b is formed over the surface 265a1, in accordance with some embodiments. The bonding layer 265b is directly bonded with the bonding layer 264, in accordance with some embodiments.

The substrate 265a includes, for example, a semiconductor substrate. In some embodiments, the substrate 265a is made of an elementary semiconductor material including silicon or germanium in a single crystal structure, a polycrystal structure, or an amorphous structure.

In some other embodiments, the substrate 265a is made of a compound semiconductor, such as silicon carbide, gallium arsenide, gallium phosphide, indium phosphide, indium arsenide, an alloy semiconductor, such as SiGe or GaAsP, or a combination thereof. The substrate 265a may also include multi-layer semiconductors, semiconductor on insulator (SOI) (such as silicon on insulator or germanium on insulator), or a combination thereof.

The bonding layer 265b is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the bonding layer 265b includes a low-k material or a porous dielectric material having a k-value which is lower than that of silicon oxide, or lower than about 3.0 or about 2.5, in accordance with some embodiments.

The bonding layer 265b is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The antireflection layer 266 is formed over a surface 261b of the substrate 261, in accordance with some embodiments. The antireflection layer 266 is made of a nitride-containing material (e.g., silicon nitride), an oxide-containing material (e.g., SiO₂ or Ta₂O₅), or another suitable material with a high light transmittance, which is higher than 99%, in accordance with some embodiments.

The optical transmission structure 267 is formed over the antireflection layer 266, in accordance with some embodiments. The optical transmission structure 267 includes a dielectric layer 267a, a waveguide structure 267b, a reflective structure 267c, and a dielectric layer 267d, in accordance with some embodiments.

The dielectric layer 267a is formed over the antireflection layer 266, in accordance with some embodiments. The dielectric layer 267a is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments. Alternatively, the dielectric layer 267a includes a low-k material or a porous dielectric material having a k-value which is lower than that of silicon oxide, or lower than about 3.0 or about 2.5, in accordance with some embodiments.

The dielectric layer 267a is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The waveguide structure 267b is formed in the dielectric layer 267a, in accordance with some embodiments. The waveguide structure 267b includes waveguide layers, in accordance with some embodiments. The waveguide structure 267b is made of a nitride-containing material (e.g., silicon nitride) or a lithium-containing material (e.g., LiNiO₂), in accordance with some embodiments.

The reflective structure 267c is formed in the dielectric layer 267a, in accordance with some embodiments. The reflective structure 267c has a trapezoidal shape, in accordance with some embodiments. The reflective structure 267c is made of metal (e.g., copper, aluminum, gold, silver, or tungsten), alloys thereof, a semiconductor material (e.g., amorphous silicon), an oxide-containing material, a dielectric material, or another suitable material with a high light reflectivity, which is higher than 99%, in accordance with some embodiments.

The dielectric layer 267d is formed in the reflective structure 267c, in accordance with some embodiments. The dielectric layer 267d has a trapezoidal shape, in accordance with some embodiments. The dielectric layer 267d is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 267d includes a low-k material or a porous dielectric material having a k-value which is lower than that of silicon oxide, or lower than about 3.0 or about 2.5, in accordance with some embodiments. In some embodiments, the dielectric layers 267a and 267d are made of the same material.

The dielectric layer 268 is formed over the optical transmission structure 267, in accordance with some embodiments. The dielectric layer 268 is directly bonded with the dielectric layer 112 of the photonic integrated circuit chip 110, in accordance with some embodiments.

The dielectric layer 268 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 268 includes a low-k material or a porous dielectric material having a k-value which is lower than that of silicon oxide, or lower than about 3.0 or about 2.5, in accordance with some embodiments.

The dielectric layer 268 is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The bonding pads 269 are formed in the dielectric layer 268, in accordance with some embodiments. The bonding pads 269 are directly bonded with the bonding pads 113 of the photonic integrated circuit chip 110, in accordance with some embodiments. The bonding pads 269 are made of a conductive material, such as metal (e.g., copper, aluminum, gold, silver, or tungsten) or alloys thereof, in accordance with some embodiments.

As shown in FIG. 2, the optical signal L passes through the waveguide structure 267b, is reflected by the reflective structure 267c, passes through the substrate 261, is reflected by the reflective structure 263c, and passes through the waveguide structure 263b, in accordance with some embodiments. Since the substrate 261 is thinner than the substrate 131 of the chip package structure 100 of FIG. 1A, the light path length of the optical signal L of FIG. 2 is less than that of FIG. 1A, which reduces the path loss of the optical signal L, in accordance with some embodiments.

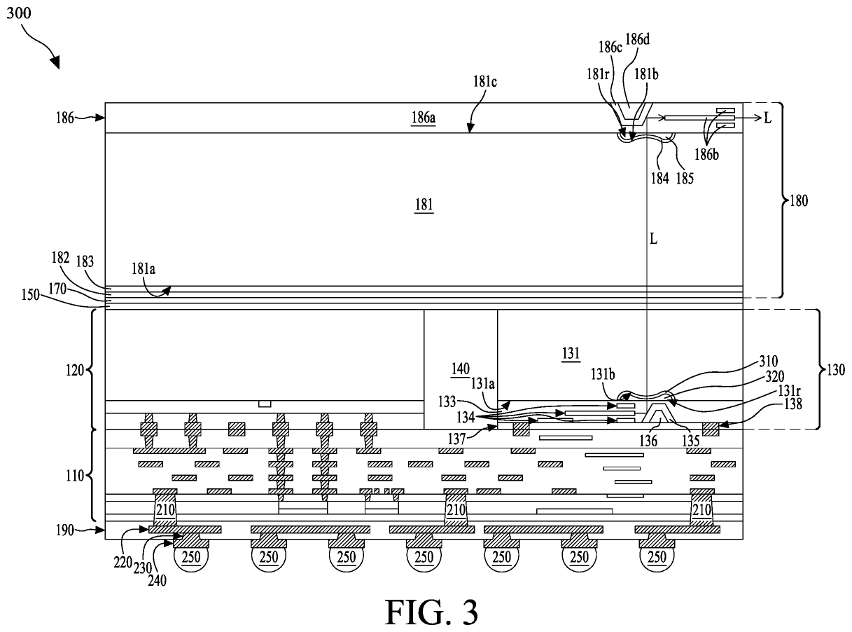

FIG. 3 is a cross-sectional view of a chip package structure 300, in accordance with some embodiments. As shown in FIG. 3, the chip package structure 300 is similar to the chip package structure 100 of FIG. 1A, except that the optical transmission chip 130 of the chip package structure 300 further includes an antireflection layer 310 and a dielectric layer 320 in the substrate 131, and the support chip 180 of the chip package structure 300 further includes an antireflection layer 183, an antireflection layer 184, a dielectric layer 185, and an optical transmission structure 186, in accordance with some embodiments. Furthermore, the chip package structure 300 does not include the optical transmission structure 160 of the chip package structure 100 of FIG. 1A, in accordance with some embodiments.

The substrate 131 has a recess 131r, in accordance with some embodiments. The recess 131r has a bottom surface, in accordance with some embodiments. The bottom surface includes a convex curved surface 131b, in accordance with some embodiments. The convex curved surface 131b faces the photonic integrated circuit chip 110, in accordance with some embodiments.

The waveguide structure 134 is partially between the convex curved surface 131b and the photonic integrated circuit chip 110, in accordance with some embodiments. The reflective structure 135 is between the convex curved surface 131b and the photonic integrated circuit chip 110, in accordance with some embodiments.

The antireflection layer 310 conformally covers the inner walls and the convex curved surface 131b of the recess 131r, in accordance with some embodiments. The dielectric layer 320 is formed over the antireflection layer 310, in accordance with some embodiments. The antireflection layer 310 is made of a nitride-containing material (e.g., silicon nitride), an oxide-containing material (e.g., SiO₂ or Ta₂O₅), or another suitable material with a high light transmittance, which is higher than 99%, in accordance with some embodiments.

The dielectric layer 320 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 320 includes a low-k material or a porous dielectric material having a k-value which is lower than that of silicon oxide, or lower than about 3.0 or about 2.5, in accordance with some embodiments. In some embodiments, the dielectric layers 133 and 320 are made of the same material. The antireflection layer 310 and the dielectric layer 320 are formed using deposition processes and a planarization process such as a chemical mechanical polishing process, in accordance with some embodiments.

The antireflection layer 183 is between the substrate 181 and the bonding layer 182, in accordance with some embodiments. The antireflection layer 183 is made of a nitride-containing material (e.g., silicon nitride), an oxide-containing material (e.g., SiO₂ or Ta₂O₅), or another suitable material with a high light transmittance, which is higher than 99%, in accordance with some embodiments.

The substrate 181 has a recess 181r, in accordance with some embodiments. The recess 181r has a bottom surface, in accordance with some embodiments. The bottom surface includes a convex curved surface 181b, in accordance with some embodiments. The convex curved surface 181b faces away from the optical transmission chip 130, in accordance with some embodiments.

The antireflection layer 184 conformally covers the inner walls and the convex curved surface 181b of the recess 181r, in accordance with some embodiments. The dielectric layer 185 is formed over the antireflection layer 184, in accordance with some embodiments. The antireflection layer 184 is made of a nitride-containing material (e.g., silicon nitride), an oxide-containing material (e.g., SiO₂ or Ta₂O₅), or another suitable material with a high light transmittance, which is higher than 99%, in accordance with some embodiments.

The dielectric layer 185 is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 185 includes a low-k material or a porous dielectric material having a k-value which is lower than that of silicon oxide, or lower than about 3.0 or about 2.5, in accordance with some embodiments. The antireflection layer 184 and the dielectric layer 185 are formed using deposition processes and a planarization process such as a chemical mechanical polishing process, in accordance with some embodiments.

The optical transmission structure 186 is formed over an upper surface 181c of the substrate 181, in accordance with some embodiments. The optical transmission structure 186 includes a dielectric layer 186a, a waveguide structure 186b, a reflective structure 186c, and a dielectric layer 186d, in accordance with some embodiments.

The dielectric layer 186a is formed over the upper surface 181c of the substrate 181, in accordance with some embodiments. The dielectric layer 186a is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments. Alternatively, the dielectric layer 186a includes a low-k material or a porous dielectric material having a k-value which is lower than that of silicon oxide, or lower than about 3.0 or about 2.5, in accordance with some embodiments.

The dielectric layer 186a is formed using a chemical vapor deposition (CVD) process, such as a low-pressure CVD process, a plasma-enhanced CVD process, or a high-density plasma CVD process, an atomic layer deposition process, a spin-on process, a physical vapor deposition process, or another suitable process.

The waveguide structure 186b is formed in the dielectric layer 186a, in accordance with some embodiments. The waveguide structure 186b overlaps the convex curved surface 181b, in accordance with some embodiments. The waveguide structure 186b includes waveguide layers, in accordance with some embodiments. The waveguide structure 186b is made of a nitride-containing material (e.g., silicon nitride) or a lithium-containing material (e.g., LiNiO₂), in accordance with some embodiments.

The reflective structure 186c is formed in the dielectric layer 186a, in accordance with some embodiments. The reflective structure 186c has a trapezoidal shape, in accordance with some embodiments. The reflective structure 186c is over the convex curved surface 181b, in accordance with some embodiments.

The reflective structure 186c is made of metal (e.g., copper, aluminum, gold, silver, or tungsten), alloys thereof, a semiconductor material (e.g., amorphous silicon), an oxide-containing material, a dielectric material, or another suitable material with a high light reflectivity, which is higher than 99%, in accordance with some embodiments.

The dielectric layer 186d is formed in the reflective structure 186c, in accordance with some embodiments. The dielectric layer 186d has a trapezoidal shape, in accordance with some embodiments. The dielectric layer 186d is made of a dielectric material such as an oxide-containing material (e.g., silicon oxide or tetraethyl orthosilicate (TEOS) oxide), an oxynitride-containing material (e.g., silicon oxynitride), a glass material (e.g., borosilicate glass (BSG), phosphoric silicate glass (PSG), borophosphosilicate glass (BPSG), or fluorinated silicate glass (FSG)), or a combination thereof, in accordance with some embodiments.

Alternatively, the dielectric layer 186d includes a low-k material or a porous dielectric material having a k-value which is lower than that of silicon oxide, or lower than about 3.0 or about 2.5, in accordance with some embodiments. In some embodiments, the dielectric layers 186a, 186d, and 185 are made of the same material.

The convex curved surface 131b of the substrate 131 and the convex curved surface 181b of the substrate 181 together form a convex lens, which can concentrate the optical signal L, in accordance with some embodiments. Therefore, the path loss of the optical signal L is reduced, in accordance with some embodiments.

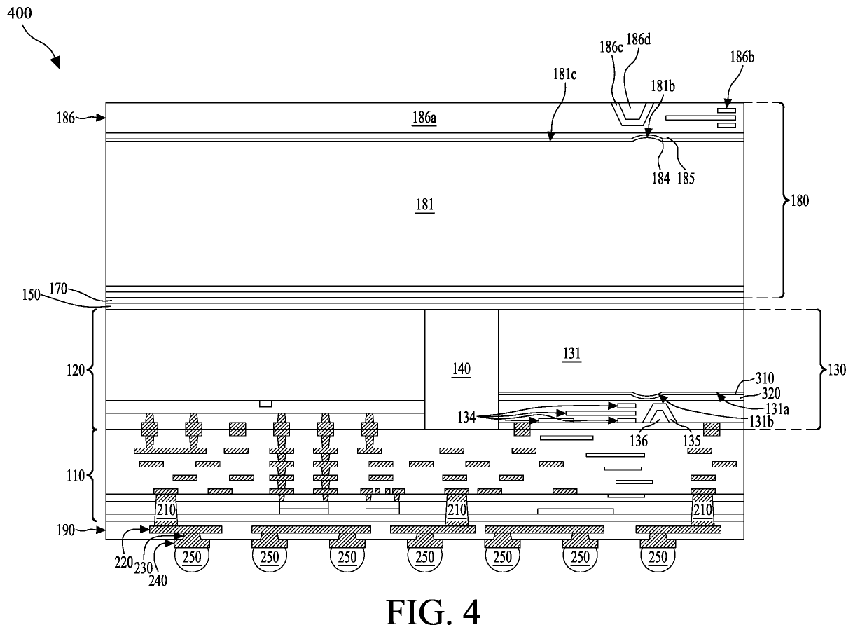

FIG. 4 is a cross-sectional view of a chip package structure 400, in accordance with some embodiments. As shown in FIG. 4, the chip package structure 400 is similar to the chip package structure 300 of FIG. 3, except that the convex curved surface 131b of the substrate 131 of the optical transmission chip 130 of the chip package structure 400 protrudes from the lower surface 131a of the substrate 131, and the convex curved surface 181b of the substrate 181 of the support chip 180 of the chip package structure 400 protrudes from the upper surface 181c of the substrate 181, in accordance with some embodiments.

The antireflection layer 310 conformally covers the convex curved surface 131b and the lower surface 131a of the substrate 131, in accordance with some embodiments. The dielectric layer 320 is formed over the antireflection layer 310, in accordance with some embodiments.

The antireflection layer 184 conformally covers the convex curved surface 181b and the upper surface 181c of the substrate 181, in accordance with some embodiments. The dielectric layer 185 is formed over the antireflection layer 184, in accordance with some embodiments.

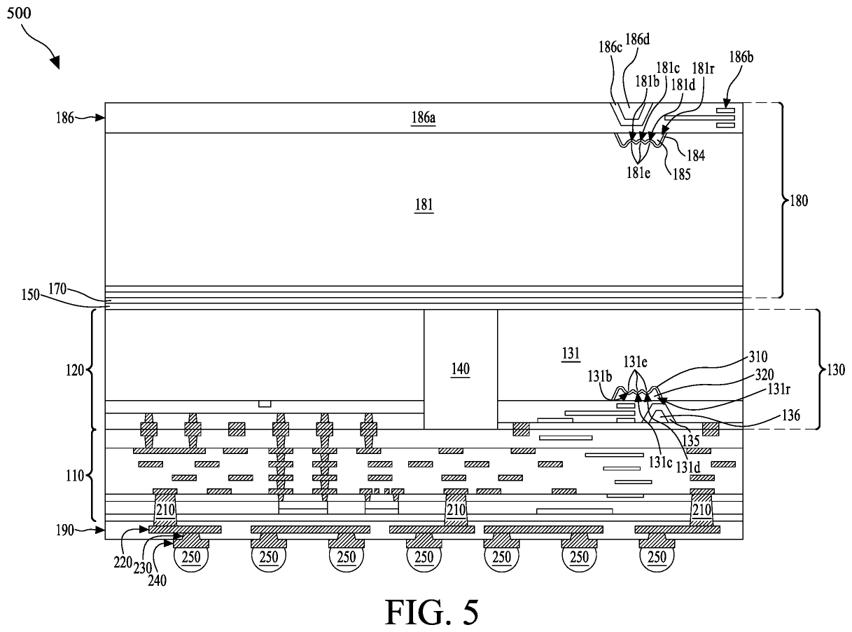

FIG. 5 is a cross-sectional view of a chip package structure 500, in accordance with some embodiments. As shown in FIG. 5, the chip package structure 500 is similar to the chip package structure 300 of FIG. 3, except that the substrate 131 of the optical transmission chip 130 of the chip package structure 500 further has convex curved surfaces 131c and 131d, and the substrate 181 of the support chip 180 of the chip package structure 500 further has convex curved surfaces 181c and 181d, in accordance with some embodiments.

The antireflection layer 310 conformally covers the inner walls and the convex curved surfaces 131b, 131c, and 131d of the recess 131r in the substrate 131, in accordance with some embodiments. The dielectric layer 320 is formed over the antireflection layer 310, in accordance with some embodiments. The portions 131e of the substrate 131 having the convex curved surfaces 131b, 131c, and 131d together form a micro-lens structure, in accordance with some embodiments.

The antireflection layer 184 conformally covers the inner walls and the convex curved surfaces 181b, 181c, and 181d of the recess 181r in the substrate 181, in accordance with some embodiments. The dielectric layer 185 is formed over the antireflection layer 184, in accordance with some embodiments. The portions 181e of the substrate 181 having the convex curved surfaces 181b, 181c, and 181d together form a micro-lens structure, in accordance with some embodiments.

Processes and materials for forming the chip package structures 200, 300, 400, and 500 may be similar to, or the same as, those for forming the chip package structure 100 described above. Elements designated by the same reference numbers as those in FIGS. 1A to 5 have structures and materials that are the same or similar. Therefore, the detailed descriptions thereof will not be repeated herein.

Other features and processes may also be included. For example, testing structures may be included to aid in the verification testing of the 3D packaging or 3DIC devices. The testing structures may include, for example, test pads formed in a redistribution layer or on a substrate that allows the testing of the 3D packaging or 3DIC, the use of probes and/or probe cards, and the like. The verification testing may be performed on intermediate structures as well as the final structure. Additionally, the structures and methods disclosed herein may be used in conjunction with testing methodologies that incorporate intermediate verification of known good dies.

In accordance with some embodiments, chip package structures and methods for forming the same are provided. The methods (for forming the chip package structure) form an additional optical transmission chip in an optical engine package structure to change the light path so as to reduce the light path length. Therefore, the path loss of the optical signal is reduced.

The methods (for forming the chip package structure) form a convex lens in an optical engine package structure to concentrate the optical signal, which reduces the path loss of the optical signal.

In accordance with some embodiments, a chip package structure is provided. The chip package structure includes a photonic integrated circuit chip including a dielectric structure, a photodetector, an optical modulator, and a first waveguide structure in the dielectric structure. The photodetector and the optical modulator are connected to the first waveguide structure. The chip package structure includes an electronic integrated circuit chip over the photonic integrated circuit chip. The electronic integrated circuit chip includes a transistor. The chip package structure includes an optical transmission chip over the photonic integrated circuit chip. The optical transmission chip includes a substrate, a second waveguide structure, and a first reflective structure, the second waveguide structure and the first reflective structure are between the substrate and the photonic integrated circuit chip, and a first angle between a first upper surface of the second waveguide structure and a first sidewall of the first reflective structure is greater than 90 degrees and less than 180 degrees, and the first sidewall is adjacent to the second waveguide structure.

In accordance with some embodiments, a chip package structure is provided. The chip package structure includes a photonic integrated circuit chip including a dielectric structure, a photodetector, an optical modulator, and a first waveguide structure in the dielectric structure. The photodetector and the optical modulator are coupled to the first waveguide structure. The chip package structure includes an electronic integrated circuit chip over the photonic integrated circuit chip. The electronic integrated circuit chip includes a transistor. The chip package structure includes an optical transmission chip over the photonic integrated circuit chip. The optical transmission chip includes a substrate, a second waveguide structure, and a first reflective structure, the second waveguide structure and the first reflective structure are between the substrate and the photonic integrated circuit chip and adjacent to teach other, the first reflective structure has a first sidewall and a second sidewall opposite to the first sidewall, and a first distance between the first sidewall and the second sidewall decreases toward the substrate.

In accordance with some embodiments, a chip package structure is provided. The chip package structure includes a photonic integrated circuit chip including a dielectric structure, a photodetector, an optical modulator, and a first waveguide structure in the dielectric structure. The photodetector and the optical modulator are coupled to the first waveguide structure. The chip package structure includes an electronic integrated circuit chip over the photonic integrated circuit chip. The electronic integrated circuit chip includes a transistor. The chip package structure includes an optical transmission chip over the photonic integrated circuit chip. The optical transmission chip includes a substrate and a second waveguide structure, the second waveguide structure is between the substrate and the photonic integrated circuit chip, the substrate has a first convex curved surface facing the photonic integrated circuit chip, and the second waveguide structure is between the first convex curved surface and the photonic integrated circuit chip.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A chip package structure, comprising:
a photonic integrated circuit chip comprising a dielectric structure, a photodetector, an optical modulator, and a first waveguide structure in the dielectric structure, wherein the photodetector and the optical modulator are connected to the first waveguide structure;
an electronic integrated circuit chip over the photonic integrated circuit chip, wherein the electronic integrated circuit chip comprises a transistor; and
an optical transmission chip over the photonic integrated circuit chip, wherein the optical transmission chip comprises a substrate, a second waveguide structure, and a first reflective structure, the second waveguide structure and the first reflective structure are between the substrate and the photonic integrated circuit chip, and a first angle between a first upper surface of the second waveguide structure and a first sidewall of the first reflective structure is greater than 90 degrees and less than 180 degrees, and the first sidewall is adjacent to the second waveguide structure.

2. The chip package structure as claimed in claim 1, further comprising:
a dielectric layer in the first reflective structure.

3. The chip package structure as claimed in claim 2, wherein a width of the dielectric layer decreases toward the substrate of the optical transmission chip.

4. The chip package structure as claimed in claim 1, further comprising:
a third waveguide structure over the substrate of the optical transmission chip; and
a second reflective structure over the substrate of the optical transmission chip, wherein a second angle between a second upper surface of the third waveguide structure and a second sidewall of the second reflective structure is greater than 0 degree and less than 90 degrees, and the second sidewall is adjacent to the third waveguide structure.

5. The chip package structure as claimed in claim 4, further comprising:
a dielectric layer in the second reflective structure.

6. The chip package structure as claimed in claim 5, wherein a width of the dielectric layer decreases toward the substrate of the optical transmission chip.

7. The chip package structure as claimed in claim 1, further comprising:
a molding layer between the electronic integrated circuit chip and the optical transmission chip.

8. The chip package structure as claimed in claim 7, further comprising:
a support chip over the electronic integrated circuit chip, the optical transmission chip, and the molding layer.

9. The chip package structure as claimed in claim 1, wherein the first waveguide structure overlaps the second waveguide structure in a direction perpendicular to a lower surface of the substrate of the optical transmission chip.

10. The chip package structure as claimed in claim 1, further comprising:
a dummy chip over the optical transmission chip, wherein a first top surface of the dummy chip is substantially level with a second top surface of the electronic integrated circuit chip.

11. A chip package structure, comprising:
a photonic integrated circuit chip comprising a dielectric structure, a photodetector, an optical modulator, and a first waveguide structure in the dielectric structure, wherein the photodetector and the optical modulator are coupled to the first waveguide structure;
an electronic integrated circuit chip over the photonic integrated circuit chip, wherein the electronic integrated circuit chip comprises a transistor; and
an optical transmission chip over the photonic integrated circuit chip, wherein the optical transmission chip comprises a substrate, a second waveguide structure, and a first reflective structure, the second waveguide structure and the first reflective structure are between the substrate and the photonic integrated circuit chip and adjacent to teach other, the first reflective structure has a first sidewall and a second sidewall opposite to the first sidewall, and a first distance between the first sidewall and the second sidewall decreases toward the substrate.

12. The chip package structure as claimed in claim 11, further comprising:
a second reflective structure over the substrate of the optical transmission chip, wherein the second reflective structure has a third sidewall and a fourth sidewall opposite to the third sidewall, and a second distance between the third sidewall and the fourth sidewall decreases toward the substrate.

13. The chip package structure as claimed in claim 12, wherein the first sidewall of the first reflective structure overlaps the fourth sidewall of the second reflective structure in a direction perpendicular to a lower surface of the substrate of the optical transmission chip.

14. The chip package structure as claimed in claim 12, further comprising:
an antireflection layer between the second reflective structure and the substrate of the optical transmission chip.

15. The chip package structure as claimed in claim 11, further comprising:
an antireflection layer between the first reflective structure and the substrate of the optical transmission chip.

16. A chip package structure, comprising:
a photonic integrated circuit chip comprising a dielectric structure, a photodetector, an optical modulator, and a first waveguide structure in the dielectric structure, wherein the photodetector and the optical modulator are coupled to the first waveguide structure;
an electronic integrated circuit chip over the photonic integrated circuit chip, wherein the electronic integrated circuit chip comprises a transistor; and
an optical transmission chip over the photonic integrated circuit chip, wherein the optical transmission chip comprises a substrate and a second waveguide structure, the second waveguide structure is between the substrate and the photonic integrated circuit chip, the substrate has a first convex curved surface facing the photonic integrated circuit chip, and the second waveguide structure is between the first convex curved surface and the photonic integrated circuit chip.

17. The chip package structure as claimed in claim 16, further comprising:
a first reflective structure between the first convex curved surface and the photonic integrated circuit chip and adjacent to the second waveguide structure.

18. The chip package structure as claimed in claim 17, further comprising:
a support chip over the electronic integrated circuit chip and the optical transmission chip, wherein the support chip has a second convex curved surface facing away from the optical transmission chip.

19. The chip package structure as claimed in claim 18, wherein the support chip comprises a second reflective structure over the second convex curved surface.

20. The chip package structure as claimed in claim 18, wherein the support chip comprises a third waveguide structure over the second convex curved surface.
